(19) United States
(12) Patent Application Publication
(10) Pub. No.: US 2011/0219964 A1
(43) Pub. Date: Sep. 15, 2011

(54) Method of making a keycap structure having a UV-cured resin and method of making a keyboard including keycap structures having a UV-cured resin

(76) Inventor: Chih-Chao Chen, Taoyuan (TW)

(21) Appl. No.: 12/834,907

(22) Filed: Jul. 13, 2010

(30) Foreign Application Priority Data
Mar. 15, 2010 (TW) 099107414

(51) Int. Cl. B44C 1/24

(52) U.S. Cl. 101/32

(57) ABSTRACT

A method of making a keycap structure having a UV-cured resin and making a keyboard having such keycap structures, in which a film is printed with a top color layer and then a bottom color layer, the film is hot-pressed to form a thin shell, a UV-cured resin layer is formed on the bottom color layer through a UV-curing process, and finally the film having the UV-cured resin layer is cut or punched out to form a plurality of keycap structures. A keyboard including keycap structures having a UV-cured resin may be further formed by combining the keycap structures and a set of keyboard members.

### BACKGROUND OF THE INVENTION

1. Field of the Invention

The present invention relates to a method of making a keycap structure having a UV (ultraviolet) -cured resin and a method of making a keyboard including such keycap structures, and particularly to a method of making a surface-printed keycap structure having a UV-cured resin, which has advantages and effects that the keycap structure is easily printed, the printed pattern is resistant to rubbing-off, and the manufacturing cost is low.

2. Description of the Prior Art

Keyboards are important tools for using computers. They allow data or instructions to be input quickly by users.

However, there are usually three deficiencies in the manufacturing method and the use of keycaps of conventional keyboards. First, printing is difficult. The surface of the keycap is usually made as a slight curved face for better touch and press. Since the surface is not planar, transfer printing process is relatively difficult. The print tends to deviate from a desired location and this may increase probability of defective products. Second, the pattern tends to peel off. Pattern such as character, letter, symbol, or figure is usually directly printed on the surface of the keycap through a transfer-printing process. After the keycap is used for a period of time, the pattern easily peels off due to constant rubbing, and the key will become unrecognizable. Third, it is costly for injection molding. Generally, keycaps for keyboards are conventionally massively produced by plastic injection, and the equipments for plastic injection and the peripherals will increase the production cost.

Therefore, there is still a need for a novel manufacturing process to solve the aforesaid disadvantages and problems.

### SUMMARY OF THE INVENTION

One objective of the present invention is to provide a method of making a keycap structure having a UV-cured resin and a method of making a keyboard having the keycap structures, which have advantages and effects that the keycap structure is easily printed, the printed pattern including character, letter, figure or symbol is resistant to rubbing-off, and the equipment cost is relatively low. Accordingly, the problems of difficulty of transfer printing, easiness of rubbing-off patterns, expensive equipments, and the like encountered by conventional techniques can be solved.

Herein, the term “pattern” maybe referred to as character (or Chinese character), letter, symbol or figure, and vice versa.

To solve the aforesaid problems, a method of making keycap structure having a UV-cured resin according to the present invention is provided, which comprises steps as follows:

a step of top color printing: to print a top color layer on a film and to bake the top color layer and the film, wherein the top color layer comprises a plurality of non-printed regions and the film is light-pervious;

a step of bottom color printing: to print a bottom color layer on the top color layer and to bake the bottom color layer;

a step of film hot-press forming: to place the film on a molding device to hot-press the film into a thin shell shape;

a step of resin curing: to place the hot-pressed film having the thin shell shape on a transparent molding device, to coat the hot-pressed film with a layer of UV-curable resin, and to cure the layer of UV-curable resin by irradiation of a UV light to form a UV-cured resin layer on the bottom color layer; and

a step of cutting: to cut the film and the plastic injection layer into a predetermined shape to form a plurality of keycap structures.

A method of making a keyboard including keycap structures having a UV-cured resin according to the present invention is also provided, which comprises steps as follows:

a step of top color printing: to print a top color layer on a film and to bake the top color layer and the film, in which the top color layer comprises a plurality of non-printed regions and the film is light-pervious;

a step of bottom color printing: to print a bottom color layer on the top color layer and to bake the bottom color layer;

a step of film hot-press forming: to place the film on a molding device to hot-press the film into a thin shell shape;

a step of resin curing: to place the hot-pressed film having the thin shell shape on a transparent molding device, to coat the hot-pressed film with a layer of UV-curable resin, and to cure the layer of UV-curable resin by irradiation of a UV light to form a UV-cured resin layer on the bottom color layer;

a step of cutting: to cut the film and the plastic injection layer at a predetermined place to form a plurality of keycap structures; and

a step of assembling: to combine the plurality of keycap structures and a set of keyboard members to form a keyboard having the keycap structures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating the first embodiment of a method of making a keycap structure having a UV-cured resin according to the present invention;

FIG. 2 is a schematic diagram illustrating a top color layer printed in the present invention;

FIG. 3 is a schematic cross-sectional view taken along the line III-III as shown in FIG. 2;

FIG. 4 is a schematic diagram illustrating a baking step after printing the top color layer in the present invention;

FIG. 5 is a schematic diagram illustrating a bottom color layer printed in the present invention;

FIG. 6 is a schematic diagram illustrating a baking step after printing the bottom color layer in the present invention;

FIG. 7A is a schematic diagram illustrating a situation before formation through a hot-pressing type one in the present invention;

FIG. 7B is a schematic diagram illustrating a situation after formation through a hot-pressing type one in the present invention;

FIG. 8 is a schematic diagram illustrating a hot-pressing type two in the present invention;

FIG. 9A is a schematic diagram illustrating a step for resin curing in the present invention;

FIG. 9B is a schematic diagram illustrating another step for resin curing in the present invention;

FIG. 10 is a schematic diagram illustrating a situation after resin curing in the present invention;

FIG. 11A is a schematic diagram illustrating a cutting type one in the present invention;

FIG. 11B is a schematic diagram illustrating a cutting type two in the present invention;

FIG. 12 is a schematic diagram illustrating keycap structures after a cutting step;

FIG. 13 is a cross-sectional view locally illustrating a keycap structure of the present invention;

FIG. 14 is a flowchart illustrating the second embodiment of a method of making a keycap structure having a UV-cured resin according to the present invention;

FIG. 15 is a schematic diagram illustrating the second embodiment of a method of making a keycap structure having a UV-cured resin according to the present invention;

FIG. 16 is a flow chart illustrating the third embodiment of a method of making a keycap structure having a UV-cured resin according to the present invention;

FIG. 17 is a schematic diagram illustrating the third embodiment of a method of making a keycap structure having a UV-cured resin according to the present invention;

FIG. 18 is a schematic diagram illustrating a surface of a keycap structure in the present invention;

FIG. 19 is a flow chart illustrating the first embodiment of a method of making a keyboard including keycap structures having a UV-cured resin according to the present invention;

FIG. 20 is a schematic diagram illustrating an assembly in the present invention;

FIG. 21 is a flow chart illustrating the second embodiment of a method of making a keyboard including keycap structures having a UV-cured resin according to the present invention; and

FIG. 22 is a flow chart illustrating the third embodiment of a method of making a keyboard including keycap structures having a UV-cured resin according to the present invention.

### DETAILED DESCRIPTION

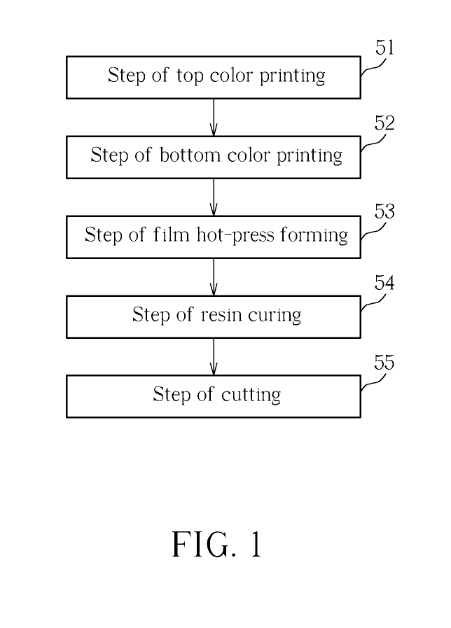

As shown in FIG. 1, a method of making a keycap structure having a UV-cured resin includes steps as follows.

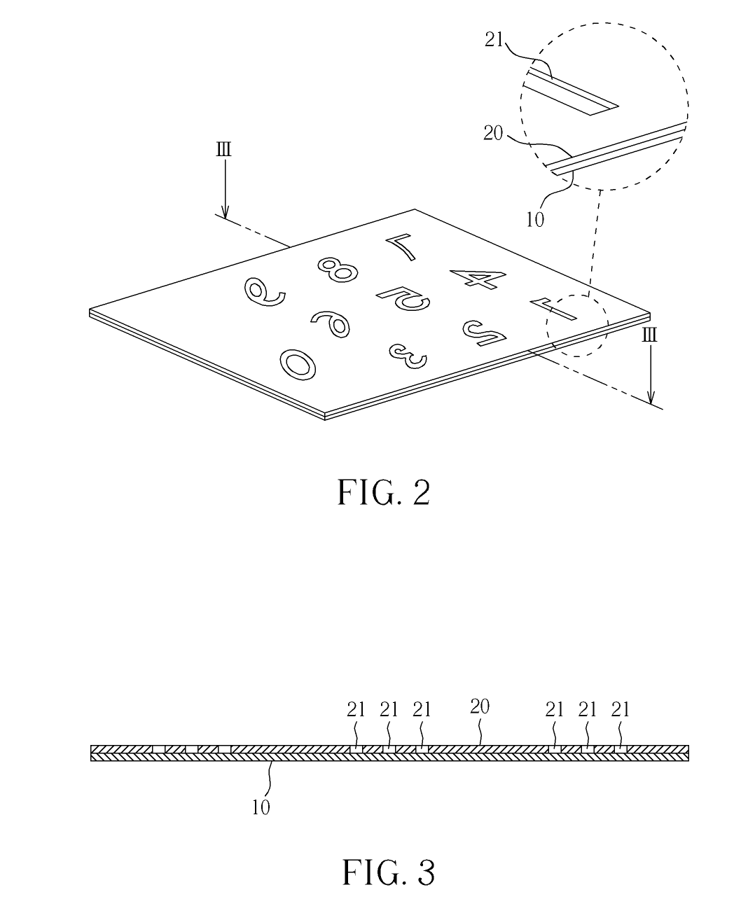

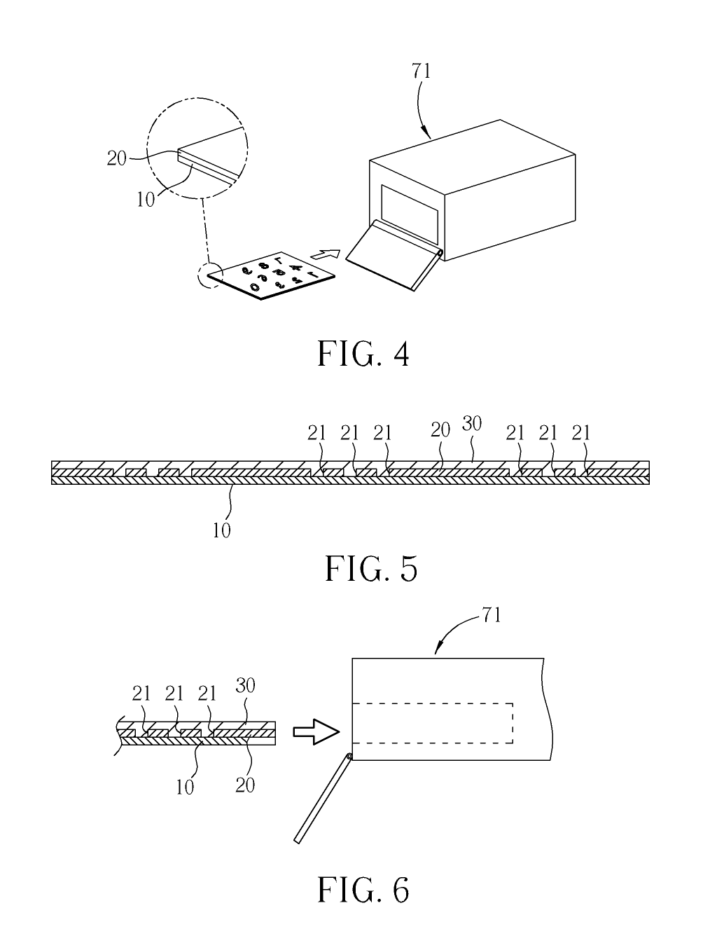

Step 51 of top color printing: As shown in FIGS. 2, 3, and 4, a film 10 is printed (such as screen-printed) with a top color layer 20, and the top color layer 20 and the film 10 are baked in an oven device 71. The top color layer 20 includes a plurality of non-printed regions 21. The non-printed region 21 is hollowed. The hollowed portion is a pattern presenting a shape of a predetermined character, letter, figure or symbol. The film 10 is light-pervious and may be for example polycarbonate (PC) film or polyethylene terephthalate (PET) film.

Step 52 of bottom color printing: As shown in FIGS. 5 and 6, after Step 51 of top color printing, a bottom color layer 30 is printed on the top color layer 20 and then baked in the oven device 71. Because the non-printed regions 21 is hollowed, when the bottom color layer 30 is printed on the top color layer 20, the bottom color layer 30 fills in the non-printed regions 21. The top color layer 20 and the bottom color layer 30 each have a predetermined color, and the colors of both are different from each other.

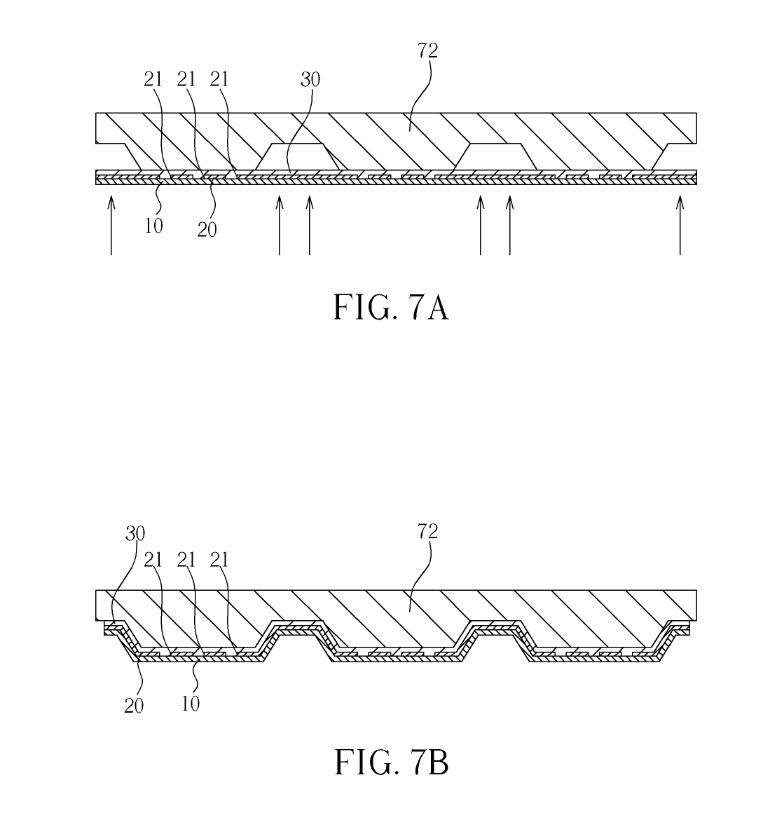

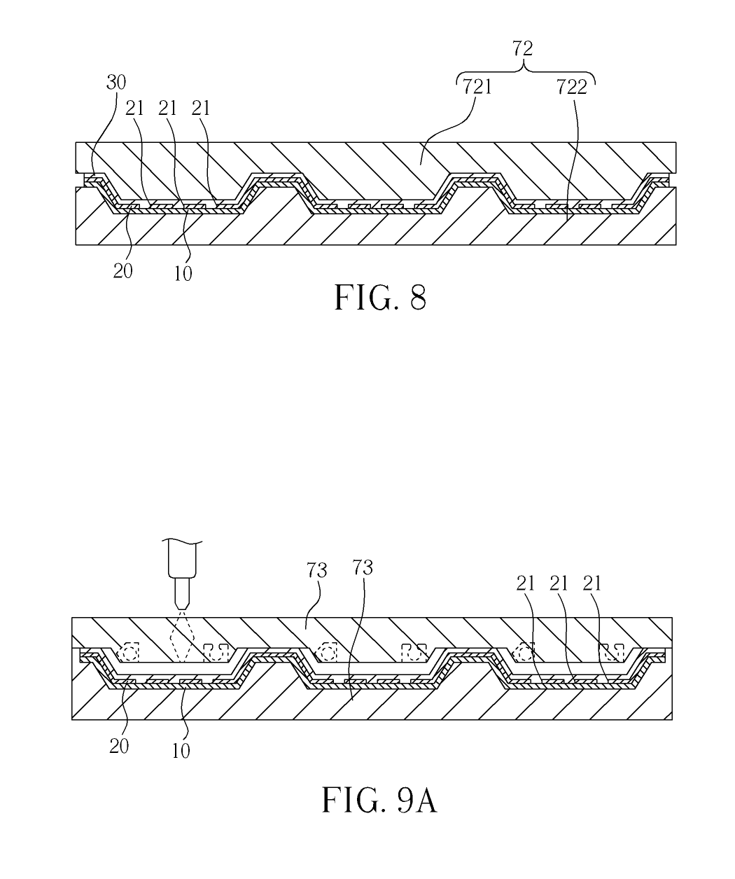

Step 53 of film hot-press forming: The film 10 printed with top color and bottom color is placed on a molding device 72 to be hot-pressed into a thin shell shape. As the hot-press method shown in FIGS. 7A and 7B, a gas pressure (shown by the arrows in FIG. 7A) is applied toward the molding device 72 to allow the film 10 which has been softened by heating to attach the molding device 72, thereby to form a shape having a concave and convex surface, like a shape of keycap structure. In other embodiment, the film 10 may be hot-pressed by a male die and a female die to form a specific shape. As shown in FIG. 8, the molding device 72 has a male die 721 and a female die 722. The male die 721 and the female die 722 are heated and closed to press the film 10 to form a specific shape. In FIG. 7A, the bottom layer 30 contacts the molding device 72 in the hot-press formation. According to a different design for the molding device 72, the relative position may be also reversed. For example, the molding device 72 may be disposed under the film 10 and the gas pressure is applied downward, i.e., in Step 53 of film hot-press forming, the surface contacting the molding device 72 may be one at the film 10 side or the bottom color layer 30 side.

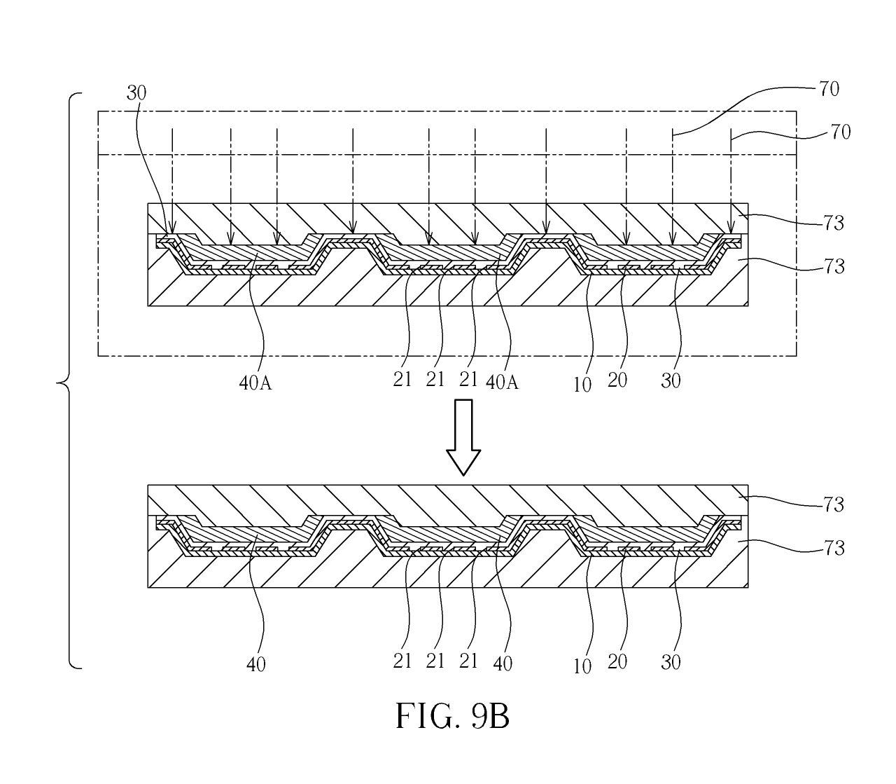

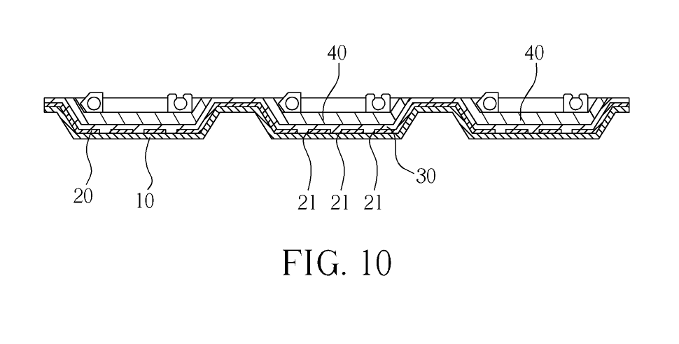

Step 54 of resin curing: As shown in FIGS. 9A, 9B and 10, the hot-pressed film 10 in a thin shell shape is taken off from the molding device 72, placed on a transparent molding device 73, and coated with a UV-curable resin 40A. After the UV-curable resin 40A is cured through irradiation of a UV light 70 to form a UV-cured resin layer 40 on the bottom color layer 30. Step 54 of resin curing may be performed so as to further make up a deficiency of the formation of the film 10 carried out in Step 53 of film hot-press forming, in addition to the main purpose of forming a thin shell on any surface of the film 10. For example, although carrying out Step 53 of film hot-press forming may give the film 10 a certain shape, the shape may shrink due to temperature or resilient properties of the material per se. Carrying out Step 54 may improve the extent of shaping of the film 10 by virtue of the pressure applied through the closure of the molding device in course of coating the UV-curable resin 40A. The transparent molding device 73 may be made of glass or other transparent material such as acrylic material and the like.

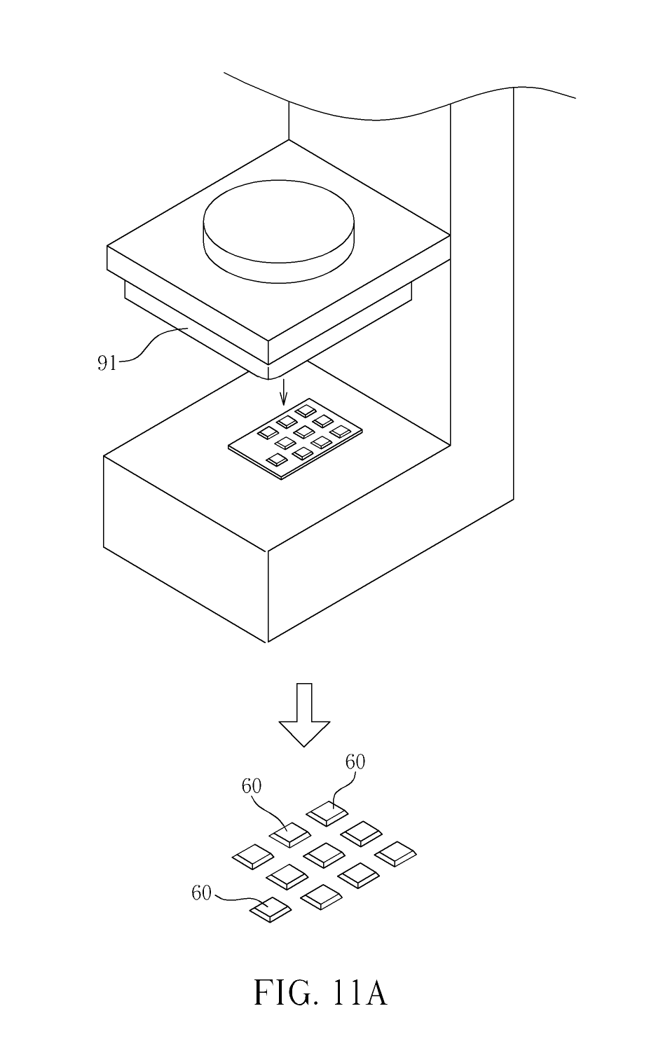

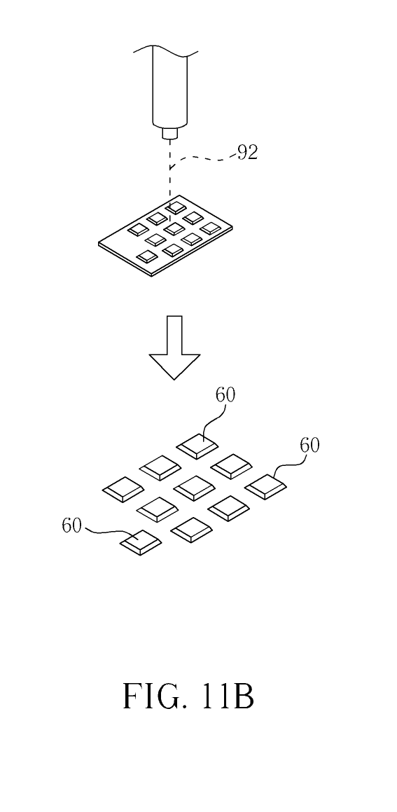

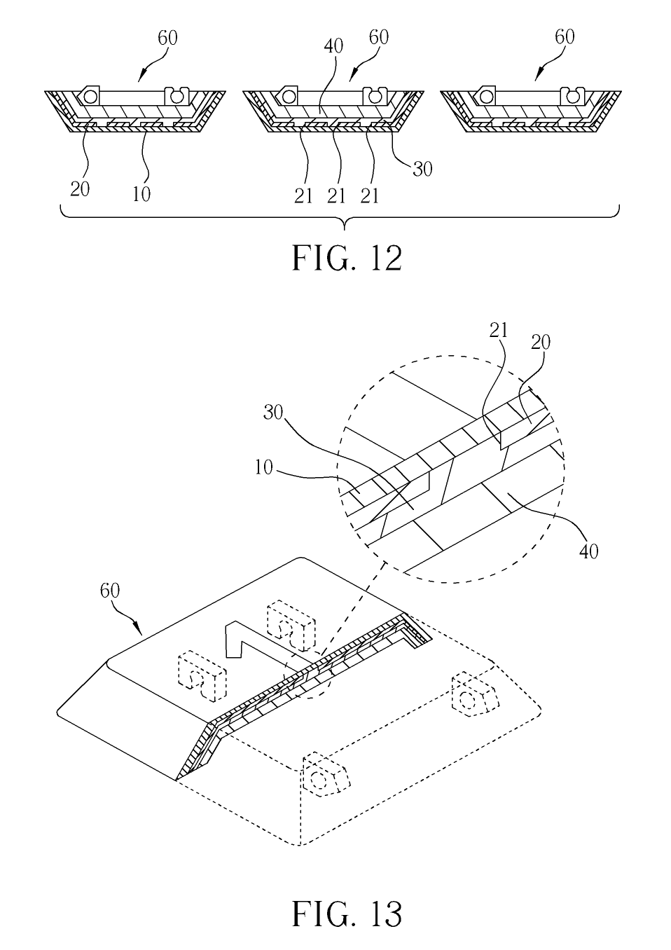

Step 55 of cutting: The film 10 having the UV-cured resin layer 40 is taken off from the transparent molding device 73 to perform a cutting step at a predetermined place, i.e. is cut into a predetermined shape, to form a plurality of keycap structures 60. As shown in FIG. 11A, the cutting may be accomplished by a punch die 91. Or, as shown in FIG. 11B, a laser beam 92 may be utilized to directly cut the joint portion (i.e. the portion without the UV-cured resin layer 40 formed thereon) between two keycap structures 60, to allow the keycap structures 60 to become discrete elements, as shown in FIGS. 12 and 13, for the following manufacturing steps. As shown in FIG. 13, because the film 10 is light-pervious, users may directly view the top color layer 20 from the outside of the keycap structure 60. The non-printed regions 21 of the hollowed top color layer 20 may allow users to easily discern the pattern (character, letter, figure, or symbol) presented by the keycap structure 60.

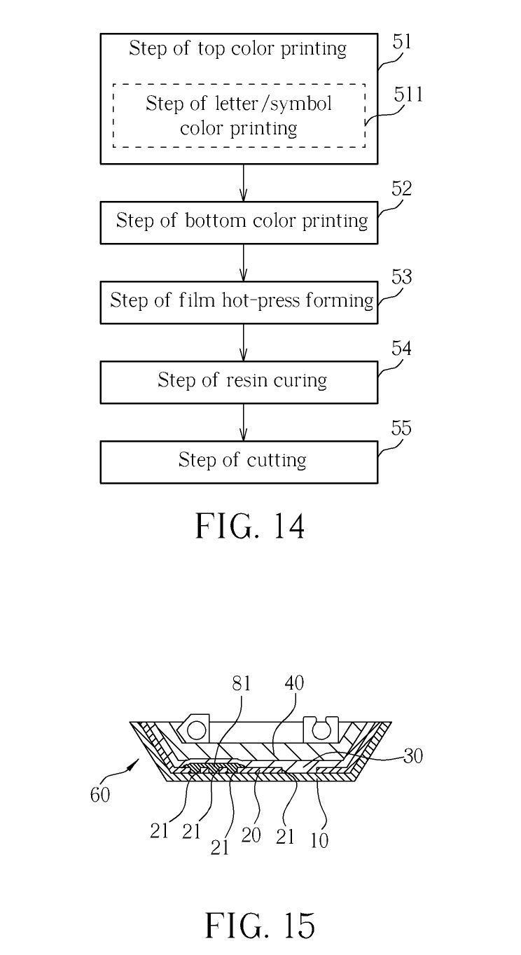

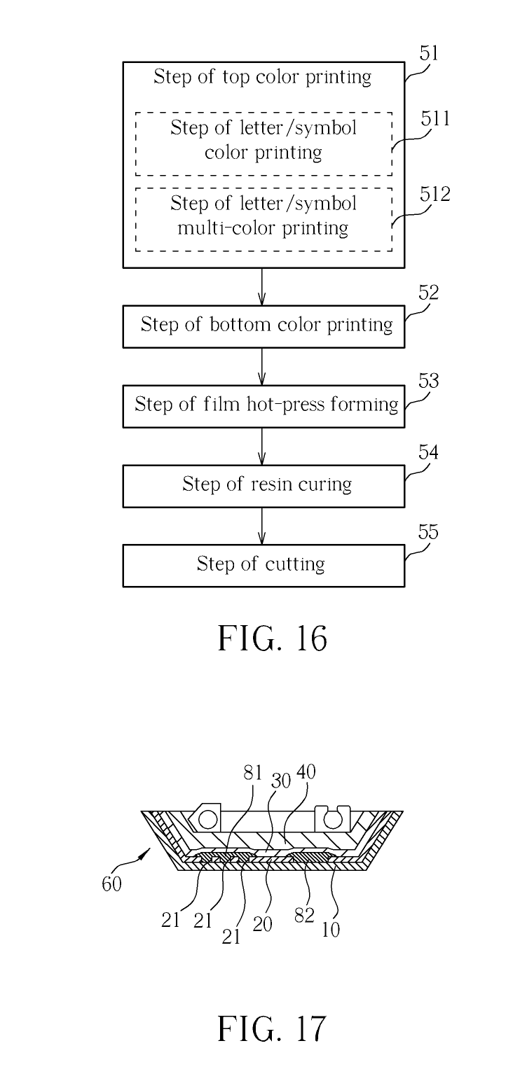

As shown in FIGS. 14 and 15, with respect to Step 51 of top color printing, Step 511 of letter/symbol (also referred to be as “pattern”) color printing is further included. A first color layer 81 is printed on at least one of the non-printed regions 21 after the top color layer 20 is printed, and then a baking step is performed. It may be realized that, as shown in FIGS. 16 and 17, Step 512 of letter/symbol multi-color printing may be still further included after the certain non-printed region 21 is printed with the first color layer 81. In Step 512, a second color layer 82 in a color other than the first color layer 81 is printed on at least one of the non-printed regions 21 which are not printed with the first color layer 81, and then a baking step is performed. Accordingly, different non-printed regions may exhibit two different colors.

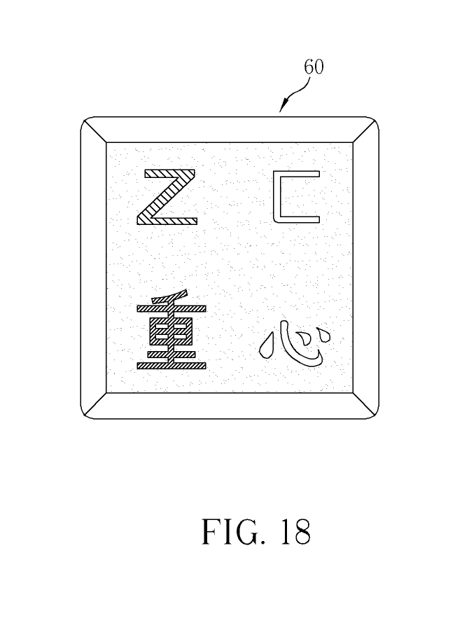

With respect to a keycap structure for a computer keyboard, it includes a plurality of letters or symbols. In the present invention, if Step 511 of letter/symbol color printing and Step 512 of letter/symbol multi-color printing are further included, at least two non-printed regions 21 can exhibit additional two colors, in addition to the color of the bottom color layer 30 . Accordingly, after a keycap structure 60 is made, the letters or symbols may have many colors. As shown in FIG. 18, after Step 511 of letter/symbol color printing and Step 512 of letter/symbol multi-color printing are further performed, letters on the keycap structure 60 may present the color of the first color layer 81, the color of the second color layer 82, and the color of the bottom color layer 30, respectively. The different colors are represented by different types of hatching. In FIG. 18, the letter “Z” and the Chinese character which is pronounced as Zhong in Chinese phonetic system exhibit the color of the first color layer 81 and the color of the second color layer 82, respectively.

After the second color layer 82 is formed, Step 512 of letter/symbol multi-color printing may be repeated to print a third color layer in another color on at least one of the non-printed regions 21 which are not printed with the second color layer 82, and then a baking process is performed. Thus, different non-printed regions 21 may exhibit three different colors. Accordingly, as long as Step 512 of letter/symbol multi-color printing is repeated, the different non-printed regions 21 may be formed in different colors.

In light of the aforesaid description, in the present invention, the printing steps are performed on the planar surface of the film 10, and accordingly the print will not deviate from a desired location easily. Furthermore, after the keycap structure 60 is accomplished, the film 10 serves as an outmost layer for protecting the top color layer 20. Thus, the keycap structure 60 can avoid the aforesaid peeling issue.

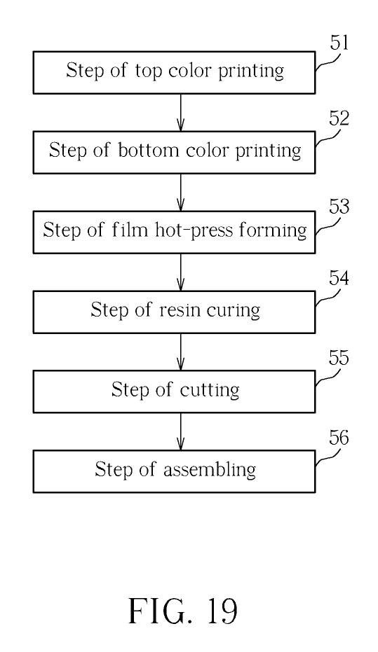

Furthermore, as shown in FIG. 19, a method of making a keyboard including keycap structures having a UV-cured resin according to the present invention is also provided. The method includes steps as follows.

Step 51 of top color printing: As shown in FIGS. 2, 3, and 4, a film 10 is printed with a top color layer 20, and the top color layer 20 and the film 10 are baked in an oven device 71. The top color layer 20 includes a plurality of non-printed regions 21.

Step 52 of bottom color printing: As shown in FIGS. 5 and 6, a bottom color layer 30 is printed on the top color layer 20 and then baked in the oven device 71.

Step 53 of film hot-press forming: The film 10 is placed on a molding device 72 to be hot-pressed into a thin shell shape.

Step 54 of resin curing: As shown in FIGS. 9 and 10, the hot-pressed film 10 in a thin shell shape is taken off from the molding device 72, placed on a transparent molding device 73, and coated with UV-curable resin 40A. A UV-cured resin layer 40 is formed on the bottom color layer 30 after the UV-curable resin 40A is cured through irradiation of a UV light 70.

Step 55 of cutting: As shown in FIGS. 11 and 12, the film 10 having the UV-cured resin layer 40 is taken off from the plastic injection mold 73 to perform a cutting step into a predetermined shape, so as to form a plurality of keycap structures 60.

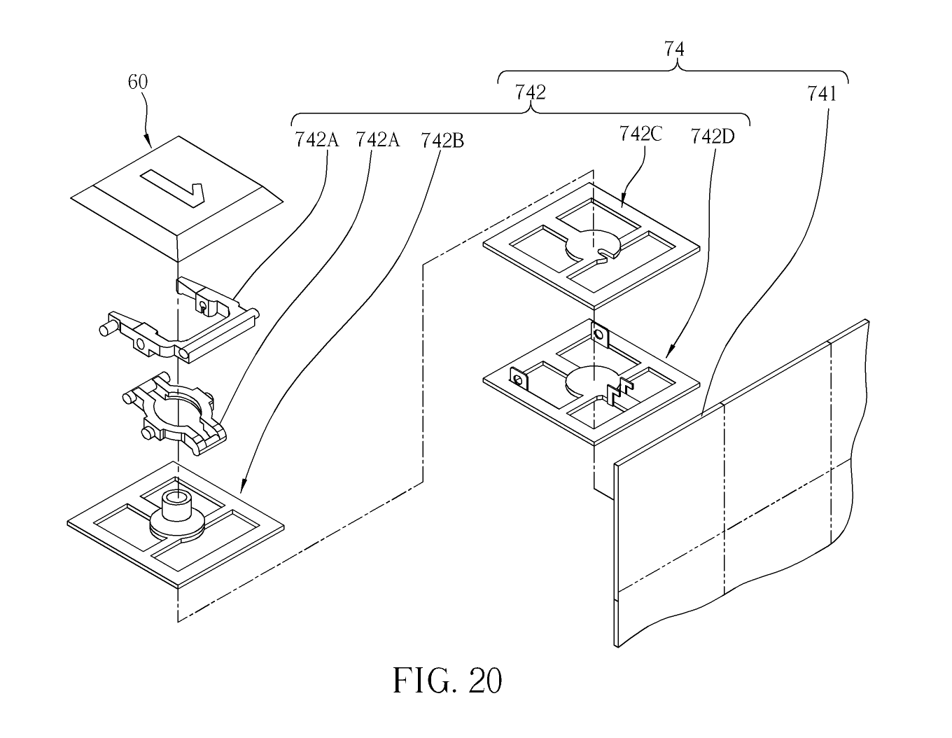

Step 56 of assembling: The plurality of keycap structures 60 and a set of keyboard members 74 are combined to form a keyboard having the keycap structures 60. As shown in FIG. 20, the set of keyboard members 74 include a light guide plate 741 and a plurality of sets of keypad members 742, each for combination with one keycap structure 60. The keypad members 742 each include a support mechanism 742A, a resilient member 742B, a thin film printed circuit board 742C, and a base 742D. In the embodiment, as shown in FIG. 20, in each of regions of the light guide plate 741 divided by imagined lines, a set of keypad members 742 can be combined with a keycap structure 60. FIG. 20 just schematically shows one assembly disposed in one of the regions.

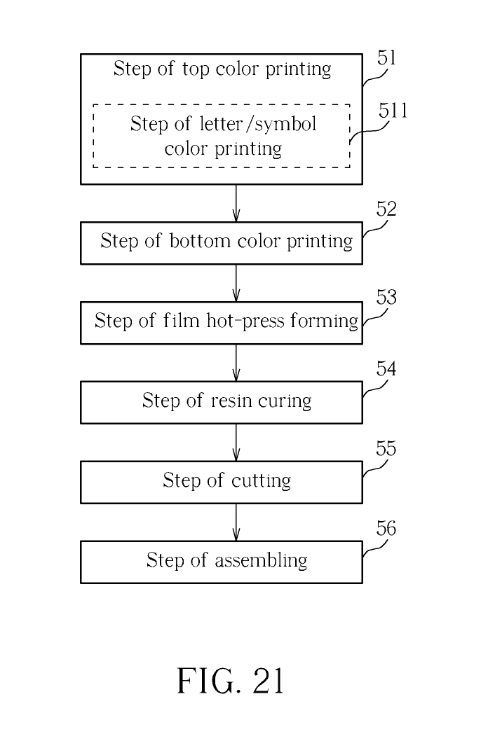

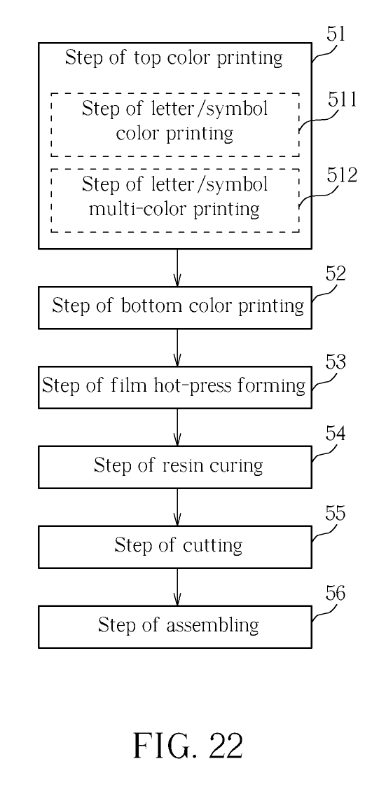

In light of the aforesaid description, with respect to the method of making a keyboard including keycap structures having a UV-cured resin, the front-end process is the same as the method of making a keycap structure. After the keycap structure 60 is made, Step 56 of assembling is additionally performed to accomplish a keyboard including keycap structures 60 having a UV-cured resin. Likewise, in the method of making a keyboard including keycap structures having a UV-cured resin, Step 51 may further include Step 511 of letter/symbol color printing to attain color variation of the letters or figures, as shown in FIG. 21. When more colors are desired, Step 512 of letter/symbol multi-color printing may be further included, to attain various color effect, as shown in FIG. 22.

In summary, the advantages and effects of the present invention can be characterized as follows.

First, the print is easy. The surface of the conventional keycap is usually made in a slight curved face so that the transfer printing process is relatively difficult. Accordingly, the print tends to deviate and the probability of defective products is increased. In the present invention, the printing steps are performed on the planar surface of the film 10, and, thereafter, the keycap structure 60 is made in a shell-shape. Accordingly, the print will not deviate from a desired location easily.

Second, the letter will not peel off due to rubbing. Pattern such as character, letter, symbol, or figure is conventionally directly printed on the surface of the keycap through a transfer-printing process. After the keycap is used for a period of time, the pattern easily peels off due to constant rubbing, and then the key is unrecognizable. In the present invention, the film 10 serves as an outmost layer for protecting the top color layer 20. Thus, the peeling issue can be avoided in use of the keycap structure 60.

Third, the manufacturing cost is lowered. Keycaps for keyboards are conventionally massively produced by plastic injection; however, the equipments for plastic injection and the peripherals will increase the production cost of a computer keyboard. In the present invention, a UV-cured resin is utilized and the conventional plastic injection process is replaced with a process of forming the UV-cured resin. Accordingly, the production cost is remarkably reduced as a whole.

Those skilled in the art will readily observe that numerous modifications and alterations of the device and method may be made while retaining the teachings of the invention.

What is claimed is:

1. A method of making a keycap structure having a UV-cured resin, comprising:
performing a step of top color printing to print a top color layer on a film and to bake the top color layer and the film, wherein the top color layer comprises a plurality of non-printed regions and the film is light-pervious;
performing a step of bottom color printing to print a bottom color layer on the top color layer and to bake the bottom color layer;
performing a step of film hot-press forming to place the film on a molding device to hot-press the film into a thin shell shape;
performing a step of resin curing to place the hot-pressed film having the thin shell shape on a transparent molding device, to coat the hot-pressed film with a layer of UV-curable resin, and to cure the layer of UV-curable resin by irradiation of a UV light to form a UV-cured resin layer on the bottom color layer; and
performing a step of cutting to cut the film having the UV-cured resin layer into a predetermined shape to form a plurality of keycap structures.

2. The method of claim 1, wherein the step of film hot-press forming comprises heating the film to soften and pressing the hot-soft film by a gas pressure applied toward the molding device to attach the molding device.

3. The method of claim 1, wherein the molding device comprises a male die and a female die and the step of film hot-press forming comprises heating the male die and the female die and closing the male die and the female die to press the film to attach the molding device.

4. The method of claim 1, wherein the step of cutting comprises punching the film having the UV-cured resin layer using a punch die.

5. The method of claim 1, wherein the step of cutting comprises cutting the film having the UV-cured resin layer by means of laser cutting.

6. The method of claim 1, wherein the step of top color printing further comprises a step of pattern color printing to print a first color layer on at least one of the non-printed regions after printing the top color layer, and to bake the first color layer.

7. The method of claim 6, wherein the step of top color printing further comprises a step of pattern multi-color printing to print a second color layer in a color other than the first color layer on at least one of the non-printed regions which are not printed with the first color layer, and to bake the second color layer.

8. The method of claim 7, wherein the step of pattern multi-color printing is repeated at least one time.

9. A method of making a keyboard including keycap structures having a UV-cured resin, comprising:
performing a step of top color printing to print a top color layer on a film and to bake the top color layer and the film, wherein the top color layer comprises a plurality of non-printed regions and the film is light-pervious;
performing a step of bottom color printing to print a bottom color layer on the top color layer and to bake the bottom color layer;
performing a step of film hot-press forming to place the film on a molding device to hot-press the film into a thin shell shape;
performing a step of resin curing to place the hot-pressed film having the thin shell shape on a transparent molding device, to coat the hot-pressed film with a layer of UV-curable resin, and to cure the layer of UV-curable resin by irradiation of a UV light to form a UV-cured resin layer on the bottom color layer;
performing a step of cutting to cut the film having the UV-cured resin layer into a predetermined shape to form a plurality of keycap structures; and
performing a step of assembling to combine the plurality of keycap structures and a set of keyboard members to forma keyboard including the keycap structures having a UV-cured resin.

10. The method of claim 9, wherein the step of film hot-press forming comprises heating the film to soften and pressing the hot-soft film by a gas pressure applied toward the molding device to attach the molding device.

11. The method of claim 9, wherein the molding device comprises a male die and a female die and the step of film hot-press forming comprises heating the male die and the female die and closing the male die and the female die to press the film to attach the molding device.

12. The method of claim 9, wherein the step of cutting comprises punching the film having the UV-cured resin layer using a punch die.

13. The method of claim 9, wherein the step of cutting comprises cutting the film having the UV-cured resin layer by means of laser cutting.

14. The method of claim 9, wherein the step of top color printing further comprises a step of pattern color printing to print a first color layer on at least one of the non-printed regions after printing the top color layer, and to bake the first color layer.

15. The method of claim 14, wherein the step of top color printing further comprises a step of pattern multi-color printing to print a second color layer in a color other than the first color layer on at least one of the non-printed regions which are not printed with the first color layer, and to bake the second color layer.

16. The method of claim 15, wherein the step of pattern multi-color printing is repeated at least one time.
